(19) United States
(12) Patent Application Publication
(10) Pub. No.: US 2025/0111598 A1
(43) Pub. Date: Apr. 3, 2025

(54) HYBRID DEFERRED DECOUPLED RENDERING

(71) Applicants: Advanced Micro Devices, Inc., Santa Clara, CA (US); ATI Technologies ULC, Markham (CA)

(72) Inventors: Michal Adam Wozniak, Santa Clara, CA (US); Guennadi Riguer, Markham (CA)

(73) Assignees: Advanced Micro Devices, Inc., Santa Clara, CA (US); ATI Technologies ULC, Markham (CA)

(21) Appl. No.: 18/477,375

(22) Filed: Sep. 28, 2023

(51) Int. Cl. G06T 15/80; G06T 15/04

(52) U.S. Cl. CPC G06T 15/80; G06T 15/04

(57) ABSTRACT

A technique for rendering is provided. The technique includes performing a visibility operation to generate shade space visibility information and reconstruction information; performing a shade space shading operation based on the shade space visibility information generate shaded shade space textures; and performing a reconstruction operation based on the reconstruction information and the shaded shade space textures.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a set of decoupled shading operations, according to an example;

FIG. 5 illustrates operations for the visibility pass and texture marking operations, according to an example;

FIG. 6 illustrates example shade space shading operations for the shade space shading operations of FIG. 4;

FIG. 7 illustrates an example reconstruction operation;

FIGS. 8A-8D illustrate example operations for performing decoupled shading, in which the reconstruction operation does not process the geometry information of the scene that has already been processed in the visibility operation.

FIG. 9 is a flow diagram of a method 900 for performing rendering operations, according to an example.

### DETAILED DESCRIPTION

A technique for rendering is provided. The technique includes performing a visibility operation to generate shade space visibility information and reconstruction information; performing a shade space shading operation based on the shade space visibility information generate shaded shade space textures; and performing a reconstruction operation based on the reconstruction information and the shaded shade space textures.

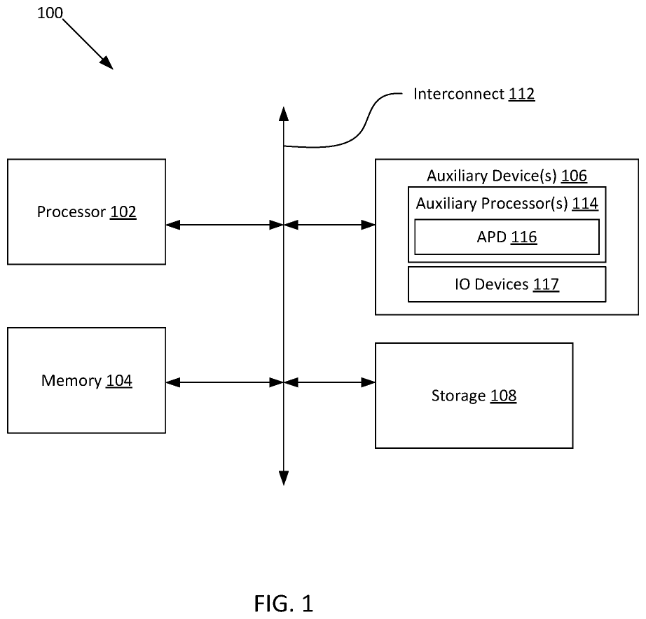

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“10”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more 10 devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

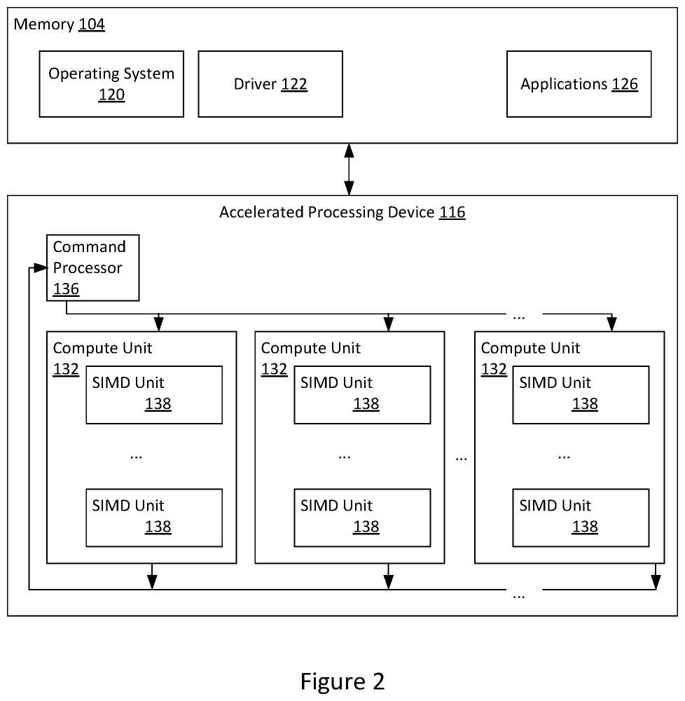

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

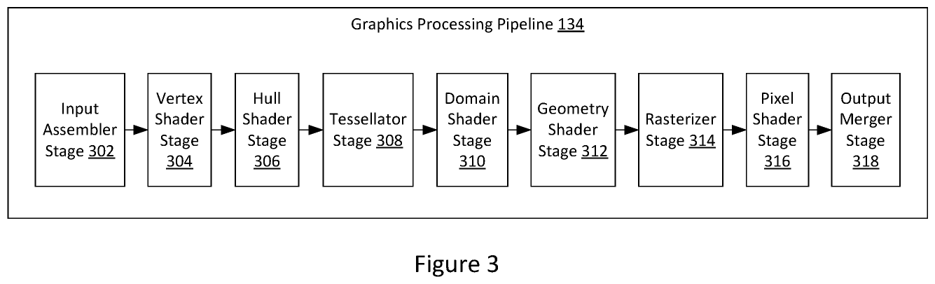

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

It is possible to perform rendering in a “decoupled” manner. Decoupled rendering involves decoupling sample shading operations from other operations in the pipeline such as geometry processing and actual application of the shading results to the objects of a three-dimensional scene. In “typical” rendering such as forward rendering, a rendering pipeline processes triangles, transforming the vertices of such triangles from world space to screen space, then rasterizes the triangles, generating fragments for shading by the pixel shader. The pixel shader shades such fragments and outputs visible fragments to the pixel buffer for final output. As can be seen, in such rendering operations, the rate at which pixel shading operations occur is directly related to the rate at which geometry sampling and final image generation is performed. Advantage can be gained by decoupling the rate at which shading operations occur from the sampling rate of the rendered image. Specifically, it might be possible to reduce the heavy workload of complex pixel shading operations while still generating frames at a high frame rate to reflect changes in geometry (e.g., camera position, rotation and scene geometry movement, rotation, and scaling) quickly over time.

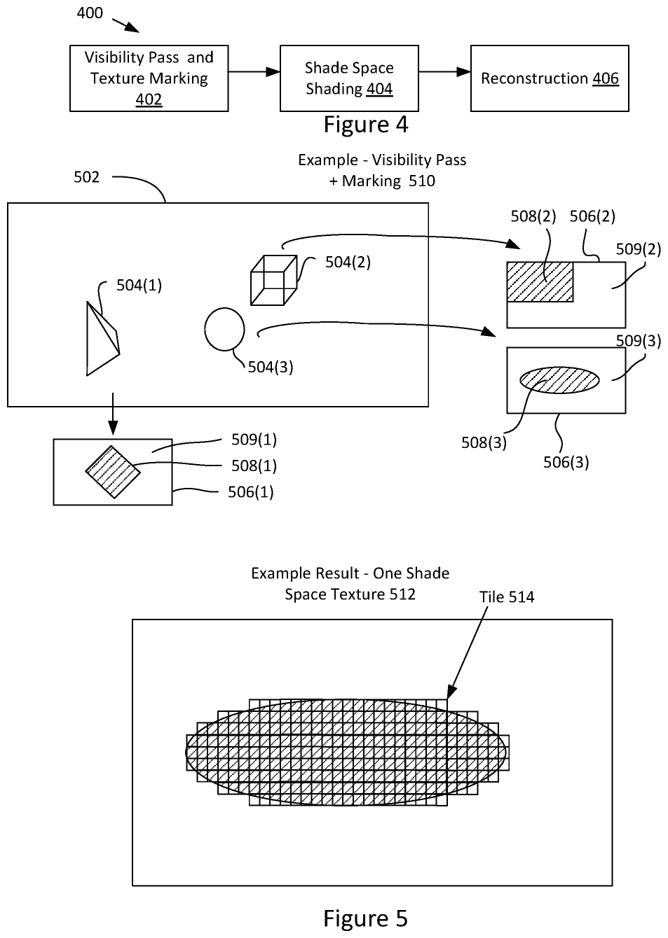

FIG. 4 illustrates a set of decoupled shading operations 400, according to an example. The set of decoupled shading operations 400 includes a visibility pass and shade space marking operation 402, a shade space shading operation 404, and a reconstruction operation 406. In some examples, any of these operations is performed by one or more of software executing on a processor (such as the compute units 132), hardware (e.g., hard-wired circuitry), or a combination of software and hardware. In various examples, any of this software includes software executing on the processor 102 (e.g., an application), software executing in the APD 116 (e.g., shader programs), any other software, or any combination thereof. In various examples, the hardware includes any of the processors illustrated (e.g., processor 102, APD 116), or other circuitry or processors not illustrated. In this disclosure, phrases such as “the APD 116 performs a task” is sometimes used. This should be understood as meaning that any technically feasible element (e.g., the software or hardware) performs such task. In addition, although various operations are described as being performed by the APD 116, in other examples, such operations are performed by other elements such as the processor 102 or another hardware or software element not described. Herein, where it is stated that software performs an operation, this should be understood as meaning that software executing on a processor performs the operation and thus that the processor performs that operation.

As a whole, the operations of FIG. 4 involve three “phases”: a visibility determination phase, a shade space texture shading phase and a reconstruction phase. The shade space texture shading phase includes shading onto shade space texture for a scene. The shade space textures can be thought of as “canvases” to which shading operations are applied. The canvases are applied to the objects of a scene in the reconstruction phase. It is possible to decouple the rate at which the shade space shading phase occurs from the rate at which the reconstruction phase occurs, providing benefits such as reduction of shading operation workload while still allowing for generating output frames at a high rate.

As described above, the objects of a scene each have one or more shade space textures. The shade space textures are mapped to the surfaces of such objects and colors in the shade space textures are applied to the objects during reconstruction 406. Utilizing the shade space textures in this manner allows for shading operations (e.g., the shade space shading operations 404) to occur in a “decoupled” manner as compared with the other rendering operations.

The visibility pass and shade space marking 402 involves marking which portions of the shade space textures are visible in a scene. In some examples, the scene is defined by a camera and objects within the scene, as well as parameters for the objects. In some examples, a portion of a shade space texture is visible in the event that that portion appears in the final scene. In some examples, the portion appears in the final scene if the portion is within the camera view, faces the camera, and is not occluded by other geometry. In some examples, the visibility pass and shade space marking operation 402 results in generating groups of samples, such as tiles, that are to be shaded in the shade space shading operation 404. Each tile is a set of texture samples of a shade space texture that is rendered into in the shade space shading operation 404 and then applied to the geometry in the reconstruction 406 operation. In some examples, each such tile is a fixed size (e.g., 8×8 texture samples or “texels”). In various examples, the visibility pass and shade space marking 402 is performed by a forward rendering pass, ray casting, or any other technically feasible technique that achieves determination of which portions of the shade space textures are visible in a scene.

The shade space shading operation 404 includes shading the visible portions of the shade space textures. In some examples, these shading operations are operations that are typically applied in the pixel shader stage 316 in “typical” rendering. Such operations include texture sampling (including filtering), applying lighting, and applying any other operations that would be performed in the pixel shader stage 316.

The reconstruction operation 406 includes applying the shade space textures to the geometry of the scene to result in a final image. In some examples, the reconstruction operation 406 processes the scene geometry through the world space pipeline, including applying the operations of the vertex shader stage 304 (e.g., vertex transforms from world-space to screen space) and the rasterizer stage 314 to generate fragments. The reconstruction operation 406 then includes applying the shade space texture to the fragments, e.g., via the pixel shader stage 316, to produce a final scene which is output via the output merger stage 318. Note that the operations of the pixel shader stage 316 in reconstruction 406 are generally much simpler and less computationally intensive than the shading operations that occur in the shade space shading operations 404. For example, while the shade space shading operations 404 perform lighting, complex texture filtering, and other operations, the reconstruction operation 406 is able to avoid many such complex pixel shading operations. In one example, the reconstruction operation 406 performs texture sampling with relatively simple filtering and omits lighting and other complex operations.

As stated above, it is possible to apply the shade space shading operation 404 at a different frequency than the reconstruction operation 406. In other words, it is possible to use the information generated by the shade space operation 404 in multiple successive reconstruction operations 406 (or reconstruction “frames”). Thus, it is possible to reduce the computational workload of the complex shading operations 404 while still generating output frames relatively quickly. The decoupled shading operations 400 will now be described in greater detail.

FIG. 5 illustrates operations for the visibility pass and texture marking operations 402, according to an example. Herein, the term “visibility pass 402” is used interchangeably with “visibility pass and texture marking operations 402.” The example visibility pass 402 is performed for a scene 502 which includes a number of objects 504. In addition, each object 504 has an associated shade space texture 506 which has a visible portion 508 and a non-visible portion 509. As can be seen, the example visibility pass 510 results in the designation of the visible portion 508 of the associated shade space texture 506.

In an example 512, the visibility pass 402 designates the visible portions 508 of the shade space textures 506 by generating tiles 514 that cover the visible portions in the following manner. The visibility pass 402 performs the operations of the graphics processing pipeline 134 in a simplified mode. Specifically, the visibility pass 402 generates tiles for the portions of the shade space texture 506 that are visible in the scene. Each tile 514 represents a portion of the shade space texture 506 that is to be shaded in the shade space shading operation 404. Tiles that are not generated are not shaded in the shade space operation 404.

In some examples, the visibility pass 402 generates tiles by using the graphics processing pipeline 134. More specifically, the geometry of the scene 502 is processed through the graphics processing pipeline 134. Information associating each fragment with a shade space texture flows through the graphics processing pipeline 134. When the final image is generated, this information is used to identify which portions of which shade space textures 506 are actually visible. More specifically, because only visible fragments exist in the final output image, the information associated with such fragments is used to determine which portions of the shade space textures 506 are visible.

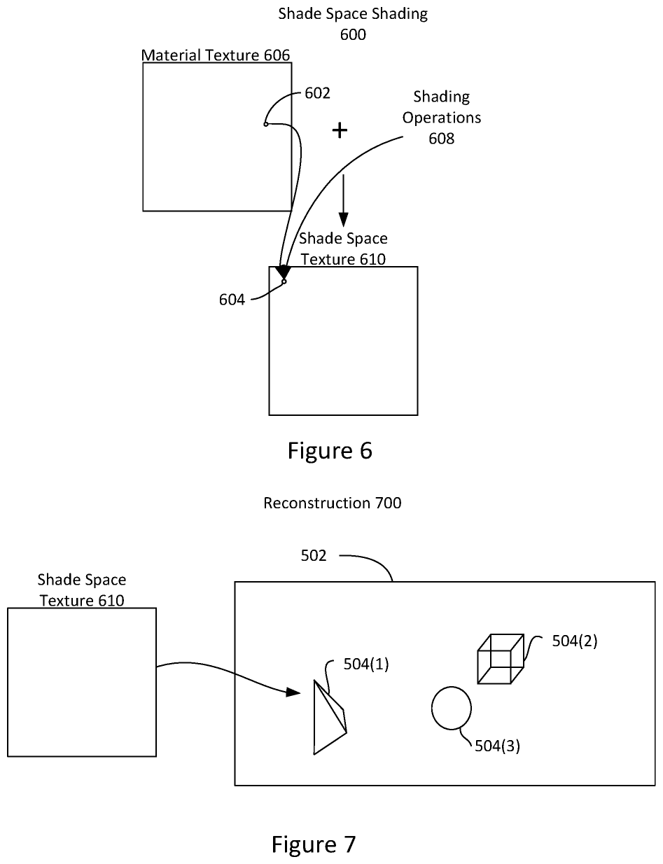

FIG. 6 illustrates example shade space shading operations 600 for the shade space shading operations 404 of FIG. 4 in accordance with a previously performed visibility determination (e.g., operation 402). The APD 116 performs shade space shading 600 by sampling a material texture 606 within a sample area 602 to obtain a texture color and applying shading operations 608 (e.g., lighting and/or other operations) as a result to generate a shade space color sample 604 for the shade space texture 610. In some examples, the shade space shading operations 600 generates texels for the entirety of each of the tiles 514 that are generated as a result of the visibility pass 402. FIG. 7 illustrates an example reconstruction operation 700. In the reconstruction operation 700, the shade space texture 610 is applied to the objects 504 within the scene. As stated elsewhere herein, in some examples, this application is performed via relatively simple texture sampling operations during rendering that sample the shade space texture 610 in a relatively simple manner and apply such samples to the objects 504 of the scene 502.

As described above, the reconstruction operation 406 involves generating an output image based on the texture shaded in the shade space shading operation 404 and the visibility operation 402. It is possible to perform the reconstruction operation 406 as a separate pass through the graphics pipeline 134, including full geometry processing of the original scene processed in the visibility pass 402. Specifically, as described elsewhere herein, a goal of the decoupled shading operations 400 is to convert input geometry specified at least by geometry vertices with attributes and other related information, into screen pixels of an image. In some examples, part of this involves the visibility pass 402, which is a pass through the graphics processing pipeline 134. In this pass, the vertex shader stage 304 processes the vertices for the geometry to be rendered to generate screen space vertices for triangles or other primitives. The visibility pass 402 also includes processing these triangles through a rasterizer to generate fragments and then processing the fragments through a subsequent shader (still part of the visibility pass 402) to generate visibility information. In general, this subsequent shader records which shade space textures are visible, and what portions of those textures are visible. In some examples, this recording is accomplished by noting the mesh IDs and the shade space texture coordinates at defined granularity (e.g., per sample or per tile of samples) for each pixel in the final buffer output for the visibility pass 402. In other words, the visibility pass 402 generates shade space samples for output pixels which are determined to be visible for the scene (e.g., using a depth test and/or other visibility test). Part of generating these pixels includes identifying the texture coordinates in shade space texture for these pixels (e.g., via interpolation of shade space texture coordinates assigned to the vertices in the rasterizer stage 314), as well as an identification of the mesh ID (which corresponds to the shade space textures) for these pixels. This information is available so that the shade space shading operation 404 can shade the shade space textures as needed. In some examples, the visibility pass 402 is performed in a different manner than specified above, such as using ray tracing or in a manner that does not use the conventional rasterization based graphics processing pipeline (e.g., pipeline 134).

One possible manner in which to perform the reconstruction operation 406 is to perform a complete pass through the graphics processing pipeline 134, matching geometry processing and sampling performed during the visibility determination pass 402. In such a pass, the graphics processing pipeline 134 would again process the geometry through the vertex shader stage 304 in order to obtain primitives with vertices in screen space, and then shade those primitives based on the shade space textures generated in the shade space shading operation 404. The result is an image with the shade space textures “painted onto” the appropriate primitives. One issue with this manner of performing the reconstruction operation 406 is that the amount of work that needs to be performed is dependent on the geometry complexity of what is being rendered. More specifically, in this implementation, since the reconstruction operation 406 processes the geometry in the vertex shader stage 304, the amount of work that needs to be performed for the reconstruction operation 406 varies based on the complexity of the geometry (e.g., the number of triangles). In addition, it would be beneficial to make “late” (e.g., after visibility determination) decisions about shade space level of detail and maintain consistency of such decisions with the reconstruction phase, which must match the visibility and shading. For these reasons, a different technique is provided herein.

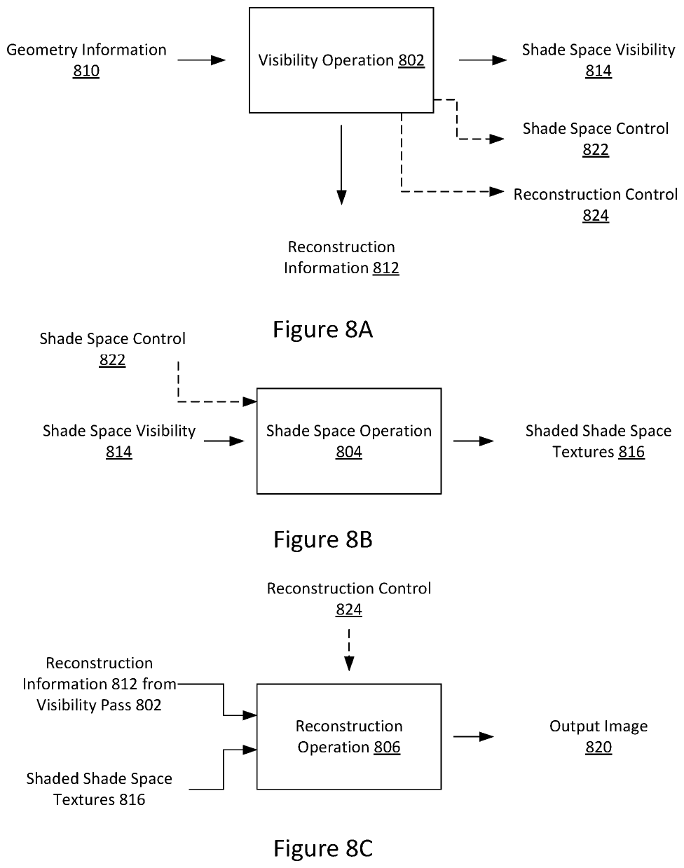

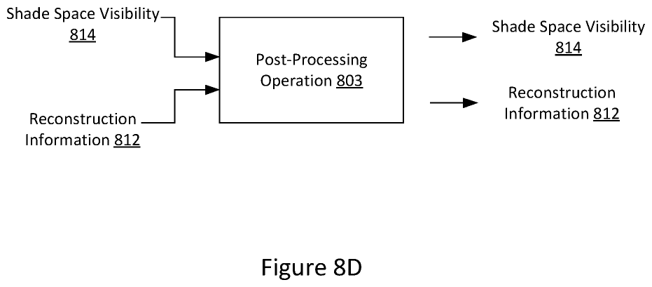

FIGS. 8A-8C illustrate example operations for performing decoupled shading, in which the reconstruction operation 806 does not process the geometry information of the scene that has already been processed in the visibility operation 802. FIG. 8A illustrates a visibility operation 802, FIG. 8B illustrates a shade space shading operation 804, and FIG. 8C illustrates a reconstruction operation 806.

In FIG. 8A, the visibility operation 802 is performed and its outputs are recorded in screen space buffers. This visibility operation 802 is similar to the visibility operation 402 of FIG. 4 and the example visibility pass 510 of FIG. 5. However, the visibility operation 802 produces some information—the reconstruction information 812—that is provided, either directly, or after some processing, to the reconstruction operation 806. The visibility operation 802 accepts geometry information 810. This geometry information includes vertices that specific primitives (e.g., triangles) with coordinates. The vertices also include texture coordinates for material textures, if applicable, and texture coordinates for the shade space textures, as well as mesh IDs for both material textures and shade space textures. The mesh IDs identify the specific textures that are associated with the vertices. The visibility operation 802 processes this geometry information 810 to generate reconstruction information 812 and shade space visibility information 814. In some examples, the reconstruction information 812 and the shade space visibility information 814 are shared and stored together.

In some examples, the visibility operation 802 processes the geometry information 810 in the following manner. To generate the shade space visibility information 814, the visibility operation 802 generates an indication for each tile of each shade space texture that is fully or partially visible in the final image (where “final image” means image generated at the end of the reconstruction operation 806). This visibility information may also include an indication of which portions of the tiles are visible. In some examples, as described above, the visibility operation 802 generates these indications based on the mesh IDs, which are provided as part of the geometry information 810. In an example, the visibility operation 802 generates output pixels based on in-flight fragments (e.g., via the rasterizer stage 314, pixel shader stage 316, and output merger stage 318). More specifically, in such examples, the rasterizer stage 314 generates fragments by evaluating primitives received from the world space pipeline (e.g., vertex shader stage 304, domain shader stage 310, or geometry shader stage 312) and generates texture coordinates for each such fragment. The remainder of the pipeline (e.g., output merger stage 318 and z-culling stages which are not shown) discards fragments that are not visible, such that what remains are the visible fragments and corresponding shade space texture coordinates and mesh IDs. The visibility operation 802 records which portions of the shade space textures are visible based on these remaining fragments, and this information is the shade space visibility information 814. While operating in the screen space to produce output 812 and 814, it is not necessary to perform a depth pre-pass as only the last visible sample will be recorded in the buffers. If on the other hand a technique that is not based on the screen space is used, a depth pre-pass would be performed in order to avoid potentially tracking portions of the shade space that are obscured by geometry closer to the viewer. More specifically, the depth pre-pass would be needed to mark only the portions of the shade space textures as visible that are both visible that pass the depth test. A depth pre-pass would be yet another geometry rendering pass that would add overhead for geometry processing. With the techniques of the present disclosure, the depth pre-pass is not needed.

In addition to generating the shade space visibility information 814, the visibility operation 802 generates the reconstruction information 812. The reconstruction information 812 includes the shade space texture coordinates, the mesh ID, the shade space level of detail, the anisotropy, and the gradients for each pixel, or any other information required by the operation of the reconstruction filter, but not available at the later processing stages. Although at least some of these values are used to generate the shade space visibility information 814, it is not strictly necessary to output these values as part of the visibility information 814. However, these values are useful for the reconstruction operation 806 to execute without performing geometry processing. More specifically, as described in further detail below, the reconstruction operation 806 is able to generate colors for each pixel based on the mesh ID (which identifies a particular shade space texture) and the shade space texture coordinates by sampling the shade space texture using those coordinates. In addition, the gradients, which describe the rate of change of the shade space texels in units of screen space (reconstruction output image) pixels, allows the reconstruction operation 806 to sample the shade space textures with the texture coordinates. The anisotropy is also a factor that assists with sampling the shade space textures, as anisotropy sometimes assists with sampling textures. In some examples, the anisotropy is derived from computed gradients. To allow the reconstruction operation 806 to have access to this information, the visibility operation 802 outputs this information (shade space texture coordinates, mesh ID, anisotropy, and gradients) as reconstruction information 812 for subsequent use.

The shade space operation 804 accepts the shade space visibility information 814 stored in screen space buffers, converts this information to a deduplicated list of shading tasks, and produces shaded shade space textures 816 as output. This operation occurs in a similar manner with respect to FIG. 4 (shade space shading operation 404).

The reconstruction operation 806 operates in the following manner. The reconstruction operation 806 accepts reconstruction information 812 from the visibility pass 802 and shaded shade space textures 816 from the shade space operation 804. In some examples, the reconstruction information 812 includes information identifying mesh ID, shade space texture coordinates, shade space level of detail, anisotropy, and gradients for each pixel of the output image. The shaded shade space textures 816 include shade space textures generated at the shade space operation 804, each including a set of texels for coloring the output image using a texture sampling operation.

The reconstruction operation 806 generates the output image 820 in the following manner. The reconstruction operation 806 generates an output value for each pixel of the output image 820. For each such pixel, the reconstruction operation 806 obtains the mesh ID, shade space texture coordinates, shade space level of detail, anisotropy, and gradients. The reconstruction operation 806 samples the appropriate texture, identified by the mesh ID, using the texture level of detail and coordinates of the pixel, the anisotropy, and the texture gradients, in order to obtain a sample for the pixel. The appropriate texture is a texture included in the shaded shade space textures 816. In some examples, the anisotropy information includes the anisotropy level and the anisotropy direction.

Regarding MIP level, mipmapping is a technique that varies texture resolution to match the screen resolution. In such a technique, the MIP level indicates a selection of a particular texture resolution.

Regarding anisotropy, anisotropic filtering is a technique to allow resolution matching between a texture and an image to which the texture is being applied, where the ratio of the texture resolution to the image resolution is substantially different in horizontal and vertical directions. In some examples, this filtering occurs by sampling the texture in a footprint whose shape matches the projected shape of a pixel of the image in the texture space. To account for the comparative resolution anisotropy, the number of texels sampled in one direction may be different than the number of texels sampled in another direction. In some examples, the anisotropy level indicates the “quality” of anisotropic filtering, with a higher level resulting in a larger number of texture samples being included in the filter footprint than for a lower anisotropy level. The gradients, and anisotropy direction (direction of the anisotropy), and anisotropy level are parameters that indicate how the shade space textures 816 are sampled for anisotropic filtering.

Together, the reconstruction information 812 allows the reconstruction operation 806 to operate in a screen space to generate an output image 820 by sampling the shade space textures according to texture sampling parameters, without needing to re-process the geometry of the input scene (geometry information 810).

It is possible to include, in the reconstruction information 812, or shade space visibility information 814, additional information. In an example, the visibility operation 802 or another operation, not shown, includes decal information in the reconstruction information 812. A decal is a texture applied on top of a rendered scene. This texture is a texture other than the shade space textures 816 generated in the shade space operation 804. In some examples, the reconstruction information 812 indicates texture coordinates for one or more decals to apply to the output image 820. In some examples, the visibility operation 802 provides a decal ID and texture coordinates for the decal for each output pixel for which a decal is to be applied. In other examples, the decal information is applied during shade space shading.

Referring now to FIGS. 8A-8C together, in some examples, the visibility operation 802 generates shade space control information 822 and reconstruction control information 824. In some examples, the shade space control information 822 varies parameters about how the shaded shade space textures 816 are generated. In some examples, shade space control information 822 indicates that one or more of the following types of information are varied. One type of information is shading rate, which can be varied either directly or via modulation, where “modulation” refers to information applied to other information that determines a shading rate. The modulation can include priority information that increases the shading rate for portions of an output image deemed more “salient.” In various examples, saliency refers to perceptual importance, which can be quantified in any technically feasible manner. In some examples, a limited shading budget exists. In such a situation, once the cost of the whole frame is evaluated, low priority portions of the shade space could be shaded at lower rates. In other words, some system (e.g., processing resource based throttling system) imposes a budget on the shading system, and in this situation, the shading rate modulation information includes information that increases the shading rate for portions deemed more “salient.” Another type of information is shade space level of detail. This specifies the resolution of the shaded textures and thus is another way to control the spatial rates. Another type of information is shading type selection and material modification. Late decisions could be made to select shading and material evaluation based on the visibility information. In an example, the shade space control information 822 could specify that the shade space shading pass should count combined opacity of blended objects and smoke particles in front of the scene geometry in question, and use simpler materials for screen pixels sufficiently obscured by smoke or other semitranslucent objects. Yet another type of information includes decal information. In some examples, the above information could be determined by a post-processing operation 803, described elsewhere herein. In addition to this, the visibility operation 802 generates reconstruction control information 824 that corresponds to the shade space control information 822. For example, if one or more of the parameters for the shade space textures is varied by the shade space control information 822, then in some examples, it is necessary for the reconstruction control information 824 to modify how reconstruction is performed in order to correspond to the modifications made to the shade space textures. In some examples, the reconstruction control information 824 change the shading rates directly or indirectly, the shade space level of detail, and this information can also apply decals. In some examples, the shade space control information 822 and the reconstruction control information apply the same changes. In some examples, the above information could be determined by a post-processing operation 803, described elsewhere herein.

FIG. 8D illustrates a post-processing operation 803, according to an example. The post-processing operation 803 is an optional operation that accepts the shade space visibility information 814 and reconstruction information 812 from the visibility operation 802, modifies that information, and outputs the modified information for input by the shade space operation 804 and the reconstruction operation 806. The post-processing operation 803 is implemented in a similar manner as the visibility operation 802, the shade space operation 804, and the reconstruction operation 806. The post-processing operation 803 modifies the above information in any technically feasible manner, such as reducing or increasing the shading rates for one or more portions of the image, or controlling the manner in which reconstruction occurs. In some examples, the post-processing operation 803 generates the shade space control information 822 and/or the reconstruction control information 824 instead of that being done by the visibility operation 802.

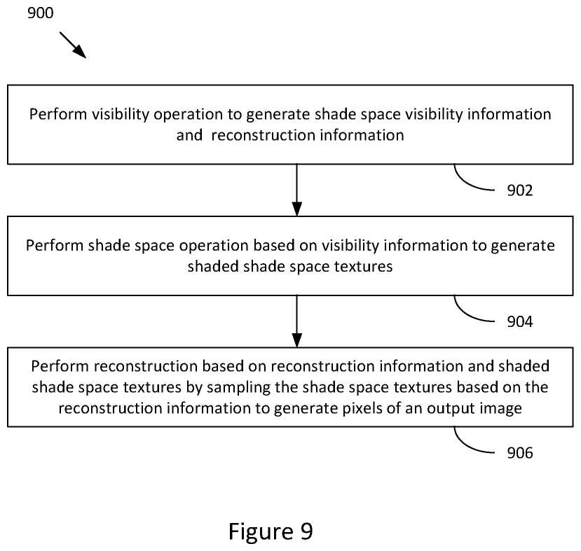

FIG. 9 is a flow diagram of a method 900 for performing rendering operations, according to an example. Although described with respect to the systems of FIGS. 1-8C, those of skill in the art will recognize that any system configured to perform the steps in any technically feasible order is contemplated by the present disclosure.

At step 902, the visibility operation 802 generates shade space visibility information 814 and reconstruction information 824 based on geometry information 810. As described elsewhere herein, the geometry information 810 includes information that describes geometry, where the geometry includes vertices specified in a first coordinate system prior to being converted to a screen space coordinate system. The vertices include attributes such as positions in the first coordinate system, mesh IDs that uniquely identify a mesh and thus both a material texture and a shade space texture, texture coordinates for the material textures that indicate the point within the material texture that is mapped to the vertex, texture coordinates for the shade space textures that map the vertices to positions in the shade space textures, and, potentially, other attributes. The shade space visibility information 814 indicates shade space textures that are visible and which portions of those shade space textures are visible.

As described elsewhere herein, the reconstruction information 812 indicates how the reconstruction operation 806 will generate the output image 820 from the shaded shade space textures 816. In some examples, the reconstruction information 812 includes, for each pixel of the output image 820 information allowing the reconstruction operation 806 to sample the appropriate shade space texture 816 to generate the output value (e.g., color) for the pixel. In some examples, this information includes one or more of the mesh ID (uniquely identifying a particular shade space texture), the texture coordinates (identifying a location in that shade space texture), and identifying other information for sampling, such as MIP level, anisotropy level, anisotropy direction, texture gradients, and/or other information. The visibility operation 802 generates this information with knowledge of the dimensions of the output image 820, so that the resolution of the output image 820 can be related to the locations, orientations, and resolutions of the shade space textures.

At step 904, the shade space operation 804 generates shaded shade space textures 816 based on the visibility information 814. As described elsewhere herein, the visibility information 814 indicates which shade space textures are visible (identified, e.g., by mesh ID), the portions of the individual textures that are visible, and which MIP level or levels should be generated for each visible portion. In some examples, the shade space visibility information 814 also indicates other information such as the material texture identifiers and texture coordinates. The shade space operation 804 shades the shade space textures based on this information. In some examples, shading the shade space textures includes shading the visible portions (e.g., the tiles of the visible portions), which includes generating sample values (e.g., colors) based on operations and information specified by shading operations (e.g., based on the contents of a pixel shader). In some examples, the shade space operation 804 performs the operations of the pixel shader stage 316, such as texture sampling for a material texture, applying lighting, or applying any of a variety of effects as specified by a pixel shader program. In other words, in some examples, the shade space operation 804 applies one or more shader programs to generate colors for the shade space textures, based on the shade space visibility information 814 output by the visibility operation 802.

At step 906, the reconstruction operation 806 performs reconstruction based on the reconstruction information 812 and the shaded shade space textures 816. In some examples, this reconstruction includes shading each pixel of the output image based on the reconstruction information 812 and the shaded shade space textures 816. In some examples, the reconstruction includes, for each pixel of the output image 820, the shading includes identifying an appropriate shade space texture based on the mesh ID and, in some examples, the MIP level. In some examples, the shading also includes obtaining the texture coordinates and, in various examples, anisotropy level, anisotropy direction, and other features as described elsewhere herein or as otherwise is technically feasible. The shading utilizes this information to sample the appropriate shaded shade space texture 816.

As described elsewhere herein, in some examples, the visibility operation 802 generates the shade space control information 822 and the reconstruction control information 824. In some examples, this shade space control information 822 is used by the shade space operation 804 to generate the shaded shade space textures 816 and the reconstruction operation 806 utilizes the reconstruction control information 824 to generate the output image.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, or output merger stage 318 are implemented fully in hardware, fully in software executing on processing units, or as a combination thereof. The visibility operation 802, shade space operation 804, and reconstruction operation 806 represent activity performed by a processor such as the processor 102 or APD 116. In various examples, any of the hardware described herein includes any technically feasible form of electronic circuitry hardware, such as hard-wired circuitry, programmable digital or analog processors, configurable logic gates (such as would be present in afield programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering to generate an output image, the method comprising:
performing a visibility operation to generate shade space visibility information and reconstruction information;
performing a shade space shading operation based on the shade space visibility information to generate shaded shade space textures; and
performing a reconstruction operation based on the reconstruction information and the shaded shade space textures.

2. The method of claim 1, wherein performing the reconstruction operation includes sampling the shaded shade space textures based on the reconstruction information to generate the output image.

3. The method of claim 1, wherein the reconstruction information includes information for a pixel of the output image that uniquely identifies a shaded shade space texture of the shaded shade space textures.

4. The method of claim 3, wherein the reconstruction information includes information for the pixel that identifies a location within the shade space texture.

5. The method of claim 3, wherein the reconstruction information includes one or more of a MIP level, an anisotropy level, an anisotropy direction, and texture gradients.

6. The method of claim 1, wherein generating the reconstruction information includes interpolating shade space texture coordinates for object vertices to generate texture coordinates for a pixel of an output image.

7. The method of claim 1, further comprising generating shade space control information and reconstruction control information.

8. The method of claim 7, wherein shade space shading operation is based on the shade space control information and the reconstruction operation is based on the reconstruction control information.

9. The method of claim 8, wherein the shade space control information and reconstruction control information include information that varies shading rates.

10. A system comprising:
a memory configured to store an output image; and
a processor configured to generate the output image by performing operations including:
performing a visibility operation to generate shade space visibility information and reconstruction information;
performing a shade space shading operation based on the shade space visibility information generate shaded shade space textures; and
performing a reconstruction operation based on the reconstruction information and the shaded shade space textures.

11. The system of claim 10, wherein performing the reconstruction operation includes sampling the shaded shade space textures based on the reconstruction information to generate the output image.

12. The system of claim 10, wherein the reconstruction information includes information for a pixel of the output image that uniquely identifies a shaded shade space texture of the shaded shade space textures.

13. The system of claim 12, wherein the reconstruction information includes information for the pixel that identifies a location within the shade space texture.

14. The system of claim 12, wherein the reconstruction information includes one or more of a MIP level, an anisotropy level, an anisotropy direction, and texture gradients.

15. The system of claim 10, wherein generating the reconstruction information includes interpolating shade space texture coordinates for object vertices to generate texture coordinates for a pixel of an output image.

16. The system of claim 10, wherein the processor is further configured to generate shade space control information and reconstruction control information.

17. The system of claim 16, wherein shade space shading operation is based on the shade space control information and the reconstruction operation is based on the reconstruction control information.

18. The system of claim 17, wherein the shade space control information and reconstruction control information include information that varies shading rates.

19. A non-transitory computer-readable medium storing instructions that, when executed by a processor, cause the processor to perform operations comprising:
performing a visibility operation to generate shade space visibility information and reconstruction information;
performing a shade space shading operation based on the shade space visibility information generate shaded shade space textures; and
performing a reconstruction operation based on the reconstruction information and the shaded shade space textures.

20. The non-transitory computer-readable medium of claim 19, wherein performing the reconstruction operation includes sampling the shaded shade space textures based on the reconstruction information to generate an output image.
